(19) United States
(12) Patent Application Publication
(10) Pub. No.: US 2013/0070478 A1
(43) Pub. Date: Mar. 21, 2013

(54) LIGHT DISTRIBUTION CONTROL MEMBER AND ILLUMINATING DEVICE USING THE SAME

(71) Applicants: Takashi EDAMITSU, Kitasaku-gun (JP); Shun KATOH, Kitasaku-gun (JP)

(72) Inventors: Takashi EDAMITSU, Kitasaku-gun (JP); Shun KATOH, Kitasaku-gun (JP)

(73) Assignee: MINEBEA CO., LTD., Kitasaku-gun (JP)

(21) Appl. No.: 13/610,046

(22) Filed: Sep. 11, 2012

(30) Foreign Application Priority Data
Sep. 20, 2011 (JP) 2011-204680

(51) Int. Cl. F21V 5/02; F21V 8/00

(52) U.S. Cl. 362/608; 362/339; 362/311.06

(57) ABSTRACT

There is provided a light distribution control member with a plurality of first prisms that have inclined surfaces of which each edge of a hexagon is a base edge, and a plurality of second prisms that have inclined surfaces of which each edge of a triangle is a base edge. The first prisms are arranged in a houndstooth pattern, and the second prisms are arranged in areas surrounded by three first prisms.

### BACKGROUND OF THE INVENTION

1. Field of the Invention

The present invention relates to a light distribution control member capable of improving the uniformity of illuminance on a surface to be illuminated, and an illuminating device using the light distribution control member.

2. Description of the Related Art

An illuminating device generally has light distribution properties in which the luminous intensity is the greatest at the front face of the light emitting surface and the luminous intensity decreases as the angle from the front face increases. In an illuminating device with such light distribution properties, there has been a problem in that the illuminance on the surface to be illuminated (for example, the floor surface in the case that this kind of illuminating device is used by attaching it to a ceiling as indoor lighting), which is positioned at a distance from the illuminating device, is high only directly below the illuminating device, and rapidly decreases towards the periphery. Conventionally, in order to avoid this problem and achieve a uniform illuminance in a comparatively wide area on the surface to be illuminated, it has been known to configure the light distribution properties of the illuminating device in a batwing manner to be explained below.

FIG. 7A shows arrangement wherein an illuminating device 100 is attached to a ceiling 102 to illuminate a floor surface 104 in an indoor space 106. Further, FIG. 7B is a graph showing the luminous intensity distributions L1 and L2 of the illuminating device 100 relative to a deflection angle θ from an optical axis q at one transect (for example, Po) including a reference axis q of the light distribution properties of the illuminating device 100. Herein, the reference axis q of the light distribution properties is normally the central axis in the front direction of the light emitting surface, and hereinafter the reference axis will also be referred to as the “optical axis”. Also, the deflection angle θ from the optical axis q will also be referred to as the “light distribution angle”, and the luminous intensity distribution relative to the light distribution angle θ will also be referred to as the “luminous intensity angular distribution”.

FIG. 7C is a graph showing the illuminance distributions (hereinafter referred to as the “illuminance angular distributions”) E1 and E2 on the floor surface 104 corresponding to each of the luminous intensity angular distributions L1 and L2 shown in FIG. 7B. In FIGS. 7B and 7C, the numerical values (−90 to 90) shown along the perimeter of the circle represent the light distribution angle θ, and the luminous intensity at each light distribution angle θ is shown as a relative value wherein the value at the angle of highest luminous intensity is 1. The illuminance is also shown as a relative value wherein the illuminance on the optical axis q (in other words, when θ=0°) is 1.

The luminous intensity angular distribution L2 shown in FIG. 7B corresponds to the general light distribution properties discussed above. In this case, the luminous intensity of the planar illuminating device 100 reaches a maximum at the direction of θ=0, and decreases as the absolute value of the light distribution angle θ increases. Here, the illuminance on the floor surface 104 rapidly decreases as the absolute, value of the light distribution angle θ increases (even though the luminous intensity angular distribution L2 is relatively uniform in the range of −25° to 25°), as can be understood from the corresponding illuminance angular distribution E2 shown in FIG. 7C.

On the other hand, if the illuminance on the floor surface 104 should be made uniform across a relatively wide area (for example, the range of −25° to 25°) as shown by the illuminance angular distribution E1 shown in FIG. 7C, it is necessary to configure the light distribution properties of the illuminating device 100 so that the luminous intensity increases from the direction of θ=0° toward the directions of an upper and lower limit value (for example, ±25°) of the light distribution angle corresponding to the area as shown by the luminous intensity angular distribution L1 shown in FIG. 7B. In this case, the luminous intensity angular distribution has a bimodal distribution profile which has peak values at the upper and lower limit values of the light distribution angle θ, and light distribution properties having such a luminous intensity angular distribution are referred to as batwing light distribution properties.

Conventionally an illuminating device which includes a light distribution control member for configuring the light distribution properties in a batwing manner (for example, refer to Japanese Patent Application Laid-Open No. 2009-266521) has been proposed. The illuminating device disclosed in No. 2009-266521 is explained below, referring to FIG. 8.

An illuminating device 200 shown in FIG. 8A includes a light source 202, and a light distribution control member 203 that controls a light distribution mode of a light L emitted from the light source 202. The light distribution control member 203 includes a three-sided pyramid prism plate 231, and this prism plate 231 is intended to disperse the light L from the light source 202 in a batwing manner. The three-sided pyramid prism plate 231 is constituted and arranged so that its light source 202 side is a flat surface 231a and the surface on the other side is a light dispersing surface 231b. The light dispersing surface 231b includes a plurality of three-sided pyramid prisms arranged with no space in between as shown in FIG. 8B. Conventionally, as such a light distribution control member, those using multi-sided pyramid prisms such as a four-sided pyramid prism, and those using circular cone prisms are also known.

Further, in order to make the illuminances on the surface to be illuminated uniform, in addition to configuring the luminous intensity angular distribution within a transect P_{φ} including the optical axis q for an arbitrary azimuth angle φ (refer to FIG. 7A) in a batwing manner as explained above, it is important to improve the uniformity around the optical axis q (in other words, in the azimuth angle φ direction) of the luminous intensity angular distribution, and thereby improve the uniformity around the optical axis q of the illuminance on the surface to be illuminated.

Thus, referring to FIG. 9, the relationship between the shape of the prisms used in the light distribution control member and the uniformity around the optical axis q of the illuminance distribution is as follows. FIGS. 9A to 9C illustrate the illuminance distribution on the surface to be illuminated in illuminating devices including light distribution control members having prism surfaces on which prisms of three different shapes are arranged. The prisms used in the light distribution control member of each illuminating device are three-sided pyramid prisms in 9A, four-sided pyramid prisms in 9B, and circular cone prisms in 9C.

In FIGS. 9A to 9C, the illuminance distribution on the surface to be illuminated is illustrated as a lightness/darkness distribution. The lightest area (hereinafter referred to as a highlight area) represents the area in which the illuminance is the highest, and areas adjacent to the periphery of the highlight areas which are expressed darker than the highlight areas represent areas in which the illuminance is lower than that in the highlight areas. However, the lightness/darkness in the drawings and the size of the illuminance do not necessarily have a constant relationship (such as the darker the area, the lower the luminous intensity) across the entire drawing, but at the very least, areas in which the lightness/darkness is different correspond to areas in which the illuminance is different.

In FIGS. 9A to 9C, as shown in FIG. 9D, the center of the drawings corresponds to an intersection of the optical axis q and the surface to be illuminated, and the straight line passing through the center corresponds to an intersection line of the transect P_{φ} of the azimuth angle φ and the surface to be illuminated.

In FIGS. 9A and 9B, the non-uniformity of the illuminance around the optical axis q is clearly represented respectively as a six-fold rotational symmetry and a four-fold rotational symmetry of the lightness/darkness distribution. It is understood that these respectively reflect the configuration constitution of the inclined surfaces (prism surfaces) included in the arrangement of the three-sided pyramid prisms and the four-sided pyramid prisms. On the other hand, the illuminance illustrated in FIG. 9C does not show non-uniformity like in FIGS. 9A and 9B, and rather shows good uniformity around the optical axis q. Therefore, from the perspective of the uniformity around the optical axis q of the illuminance on the surface to be illuminated, it can be said that circular cone prisms are preferable as the prisms used in the light distribution control member.

### SUMMARY OF THE INVENTION

However, in circular cone prisms, the prism surface is generally constituted by a curved surface, and thus they are difficult to produce compared to multi-sided pyramid prisms whose prism surfaces are constituted by flat surfaces. Thus, light distribution control members using circular cone prisms have a problem in that the production costs are high.

In view of the above problem, an object of the present invention is to provide a light distribution control member capable of improving the uniformity around the optical axis of the illuminance on the surface to be illuminated while remaining easy and inexpensive to produce, as well as an illuminating device using the light distribution control member.

The embodiments of the invention described below are examples of the constitution of the present invention. In order to facilitate the understanding of the various constitutions of the present invention, the explanations below are divided into aspects. Each aspect does not limit the technical scope of the present invention, and the technical scope of the present invention can also include constitutions in which a portion of the constituent elements in the aspects below are substituted or deleted, or another constituent element is added upon referring to the best modes for carrying out the invention.

According to a first aspect of the invention, there is provided a light distribution control member including: a plurality of first prisms that have inclined surfaces of which each edge of a hexagon is a base edge, and a plurality of second prisms that have inclined surfaces of which each edge of a triangle is a base edge, wherein the first prisms are arranged in a houndstooth pattern, and the second prisms are arranged in areas surrounded by three first prisms.

According to the light distribution control member of the first aspect, it is possible to produce the light distribution control member easily and inexpensively by the same production process as that of a conventional light distribution control member using only three-sided pyramid prisms. At the same time, with regard to the uniformity around the optical axis of the illuminance on the surface to be illuminated of the illumination light that passes through the light distribution control member, it is possible to achieve the same performance as that of a light distribution control member using circular cone prisms.

In the light distribution control member according to the first aspect, the second prisms are arranged such that the base edge of each inclined surface of the second prisms extends along a base edge of one of the inclined surfaces of the first prisms.

According to the light distribution control member of the first aspect, the uniformity around the optical axis of the illuminance on the surface to be illuminated can be further improved.

In the light distribution control member according to the first aspect, the three first prisms surrounding one second prism are arranged in an equilateral triangular pattern.

According to the light distribution control member of the first aspect, the uniformity around the optical axis of the illuminance on the surface to be illuminated can be further improved.

In the light distribution control member according to the first aspect, the first prisms are six-sided pyramid prisms, and the second prisms are three-sided pyramid prisms.

According to the light distribution control member of the first aspect, a light distribution control member that can achieve the same performance as that of a light distribution control member using circular cone prisms with regard to the uniformity around the optical axis of the illuminance on the surface to be illuminated of the illumination light that passes through the light distribution control member can be produced more easily and inexpensively by the same production process as that of a conventional light distribution control member using only three-sided pyramid prisms.

In the light distribution control member according to the first aspect, the first prisms are six-sided truncated pyramid prisms.

According to the light distribution control member of the first aspect, since the prism formation surface of the first prisms constituted by six-sided truncated pyramid prisms has flat parts, the luminous intensity angular distribution in the batwing light distribution properties of the illumination light that passes through the light distribution control member can be arbitrarily adjusted to approach an ideal distribution for achieving a uniform illuminance in a prescribed area on a surface to be illuminated. In addition, the uniformity around the optical axis of the illuminance on the surface to be illuminated can also be further improved.

In the light distribution control member according to the first aspect, the first prisms and the second prisms are spaced apart from each other.

According to the light distribution control member of the first aspect, since there are flat parts between the prisms because the first prisms and the second prisms are arranged to be separated from each other, the luminous intensity angular distribution in the batwing light distribution properties of the illumination light that passes through the light distribution control member can be arbitrarily adjusted to approach an ideal distribution for achieving a uniform illuminance in a prescribed area on a surface to be illuminated. In addition, the uniformity around the optical axis of the illuminance on the, surface to be. illuminated can also be further improved.

According to a second aspect of the invention, there is provided an illuminating device including the light distribution control member according to the first aspect and a light source unit that emits light, toward the light distribution control member.

In the illuminating device according to the second aspect, the light source unit includes a light guide plate and a light source arranged on a side edge surface of the light guide plate.

Due to the constitutions described above, the present invention can provide a light distribution control member capable of improving the uniformity in the peripheral direction of the illuminance on the surface to be illuminated while remaining, easy and inexpensive to produce, as well as an illuminating, device using the light distribution control member.

### BRIEF DESCRIPTION OF THE DRAWINGS

FIG. 1A is a plan view schematically illustrating a portion of a prism formation surface of a light distribution control member according to a first embodiment of the present invention;

FIG. 1B is a cross-section view along line A-A in FIG. 1A, and FIG. 1C is a cross-section view along line B-B in FIG. 1A;

FIG. 2 is a side view illustrating an illuminating device in a second embodiment of the present invention;

FIG. 3 illustrates the illuminance distribution on the surface to be illuminated by the illuminating device of FIG. 2;

FIG. 4 is a plan view schematically illustrating a portion of a prism formation surface for explaining the production process of the light distribution control member;

FIG. 4A illustrates the case of the light distribution control member shown in FIG. 1;

FIG. 4B illustrates the case of a conventional light distribution control member as a comparative example;

FIG. 5A is a plan view schematically illustrating another example of a portion of the prism formation surface of the light distribution control member according to the first embodiment of the present invention;

FIG. 5B is a cross-section view along line A-A in FIG. 5A;

FIG. 6A is a plan view schematically illustrating a further example of a portion of prism formation surface of the light distribution control member according to the first embodiment of the present invention;

FIG. 6B is a cross-section view along line A-A in FIG. 6A;

FIG. 7 generally illustrates the properties of the luminous intensity angular distribution and the illuminance angular distribution of an illuminating device;

FIG. 7A illustrates a configuration constitution of an illuminating device;

FIG. 7B is a graph illustrating an example of luminous intensity angular distributions corresponding to two different light distribution properties;

FIG. 7C is a graph illustrating illuminance angular distributions corresponding respectively to the two luminous intensity angular distributions shown in FIG. 7B;

FIG. 8 illustrates an example of a conventional illuminating device;

FIG. 8A is a side cross-section view schematically illustrating the illuminating device;

FIG. 8B is a plan view illustrating the light distribution control member of the illuminating device shown in FIG. 8A;

FIG. 9 illustrates the illuminance distribution on the surface, to be illuminated by an illuminating device including a conventional light distribution control member;

FIG. 9A shows the case of an illuminating device including a light distribution control member using three-sided pyramid prisms;

FIG. 9B shows the case of an illuminating device including a light distribution control member using four-sided pyramid prisms;

FIG. 9C shows the case of an illuminating device including a light distribution control member using circular cone prisms; and

FIG. 9D illustrates the relationship between the illuminance distributions shown in FIGS. 9A to 9C and the configuration constitution shown in FIG. 7.

### DETAILED DESCRIPTION OF THE PREFERRED EMBODIMENTS

Embodiments of the present invention will be explained below based on the attached drawings. The drawings, which show all or part of a light distribution control member and an illuminating device, are schematic views which highlight the characteristics of the present invention for explanation, and the relative dimensions of each illustrated part do not necessarily reflect the actual reduced scale.

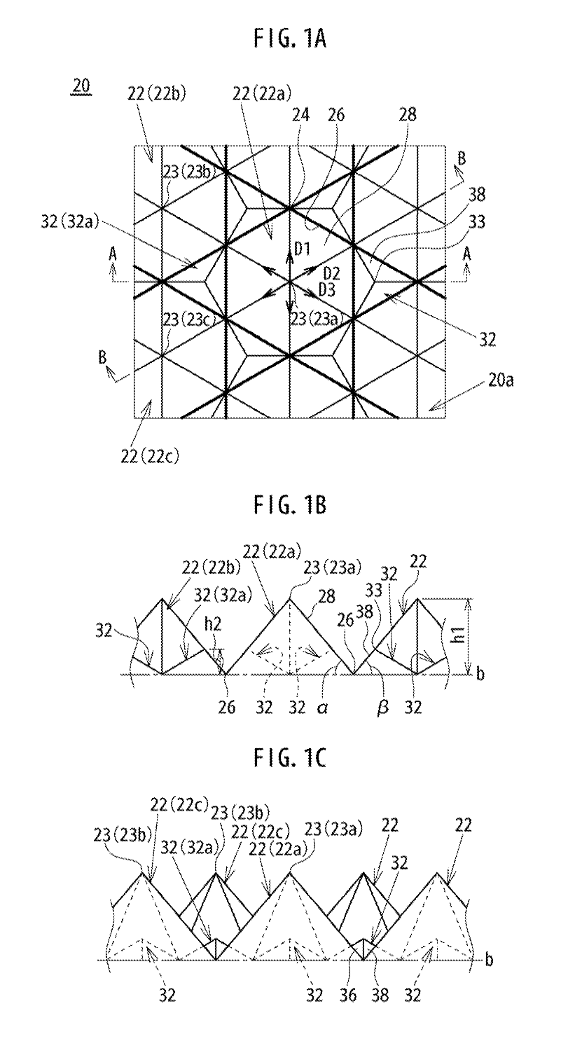

FIG. 1 illustrates a light distribution control member 20 according to a first embodiment of the present invention. The light distribution control member 20 is made by molding a transparent resin material such as a methacrylic resin or a polycarbonate resin into a plate shape. The light distribution control member 20 is constituted so that one of the principal surfaces is a prism formation surface on which first prisms 22 and second prisms 32 to be explained below are provided. FIG. 1A is a plan view schematically illustrating a portion of a prism formation surface 20a of the light distribution control member 20. FIG. 1B is a cross-section view along line A-A in FIG. 1A, and FIG. 1C is a cross-section view along line B-B in FIG. 1A. In the light distribution control member 20, the principal surface (not illustrated) on the opposite side of the prism formation surface 20a can be constituted as a fiat surface.

The light distribution control member 20 includes a plurality of first prisms 22 having inclined surfaces 28 of which each edge of a hexagon is a base edge 26, and a plurality of second prisms 32 having inclined surfaces 38 in which each edge of a triangle is a base edge 26.

Below, within a virtual plane b including each base edge 26 of the inclined surfaces 28 and 33 (refer to FIGS. 1B and 1C), a hexagonal area surrounded by the base edges 26 corresponding to one first prism 22 will be referred to as the base surface of the first prism 22, and a triangular area surrounded by the base edges 26 corresponding to one second prism 32 will be referred to as the base surface of the second prism 32.

In FIG. 1A, the base edges 26 of the inclined surfaces 28 and 38 are shown in bold lines, and ridge lines of the first and second prisms 22 and 32 constituted by the intersection lines of two inclined surfaces 28 (and two inclined surfaces 38) are shown in thin lines, simply for the purpose of facilitating the understanding of the constitution.

In the light distribution control member 20, the plurality of first prisms 22 is arranged by lining up a plurality of first prisms 22 in one line along one direction (for example, the up-down direction (D1) in FIG. 1A) within the prism formation surface 20a, and then arranging a plurality of these prism lines along a direction orthogonal to the one direction mentioned above (for example, the left-right direction in FIG. 1A). This arrangement is explained in more detail below.

First, in one prism line, a plurality of the first prisms 22 is arranged so that two adjacent first prisms 22 share one of the vertices 24 of their base surfaces, and a diagonal line connecting two vertices 24 that are shared by an adjacent first prism among the vertices 24 of the base surface of each first prism 22 follows a single straight line throughout the entire prism line.

Two adjacent prism lines are lined up so that in any one of the first prisms 22 in one prism line, the two vertices 24 on a side facing the other prism line among the four vertices 24 of the base surface that are not shared by an adjacent first prism 22 within the prism line to which that first prism 22 belongs are shared respectively by one vertex 24 among the vertices 24 of the base surface of one first prism 22 of the other prism line and one vertex 24 among the vertices 24 of the base surface of one first prism 22 that is adjacent to the first prism 22 within the other prism line.

In this way, the plurality of first prisms 22 is arranged in an overall houndstooth pattern. According to this arrangement, a triangular area is formed that is surrounded by three first prisms 22 (for example, 22a, 22b, and 22c) including one first prism 22 (for example, 22a), and the two adjacent first prisms 22 (for example, 22b and 22c) that have base surfaces in which a vertex 24 exists that is shared by a vertex 24 of the base surface of the first prism 22a within the prism line adjacent to the prism line to which the first prism 22a belongs. A second prism 32 (for example, 32a) is arranged in this triangular area.

In the light distribution control member 20, the base edges 26 of the three inclined surfaces of the second prism 32a are common with the respective base edges 26 of the three first prisms 22a, 22b, and 22c that define the triangular area in which the second prism 32a is arranged. In this respect, the base edges 26 of the three inclined surfaces of the second prism 32a extend along the corresponding base edges 26 of the three first prisms 22a, 22b, and 22c. The second prism 32a has a base surface defined by the three base edges 26.

In the above explanation, the up-down direction (D1) in FIG. 1A was given as an example of the direction in which the prism line extends, and the left-right direction in FIG. 1A was given as an example of the direction in which the plurality of prism lines is aligned. However, the arrangement constitution of the prism formation surface 20a can also be regarded as a constitution in which the prism lines in which a plurality of first prisms 22 is lined up extend in the lower left-upper right diagonal direction (D2) in FIG. 1A, and a plurality of the prism lines is aligned in a direction orthogonal to the diagonal direction D2, or a constitution in which the prism lines described above extend in the lower right-upper left diagonal direction (D3) in FIG. 1A, and a plurality of the prism lines is aligned in a direction orthogonal to the diagonal direction D3. In either case, the first prisms 22 and the second prisms 23 are arranged as described above.

In the light distribution control member 20, each inclined surface 28 of the first prisms 22 forms a triangle that rises up from the corresponding base edge 26. Thereby, the first prisms 22 are constituted as convex six-sided pyramid prisms. Similarly, each inclined surface 38 of the second prisms 32 forms a triangle that rises up from the corresponding base edge 26. Thereby, the second prisms 32 are constituted as convex three-sided pyramid prisms.

Here, in the first and second prisms 22 and 32, an inclination angle α of the inclined surfaces 28 of the first prisms 22 and an inclination angle β of the inclined surfaces 38 of the second prisms 32 are equivalent to each other, and a height h2 of the second prisms 32 is lower than a height h1 of the first prisms 22.

In the light distribution control member 20, the base surfaces of the plurality of first prisms 22 is mutually equilateral congruent hexagons, and the base surfaces or the plurality of second prisms 32 is mutually congruent equilateral triangles. In this case, the three first prisms 22 that surround each second prism 32 are arranged in an equilateral triangle pattern. For example, the vertices (for example, vertices 23a, 23b, and 23c that do not exist on the base surface) corresponding to the three first prisms 22 that surround the second prism 32a form the vertices of an equilateral triangle in a plan view.

In the example shown in FIG. 1, the first prisms 22 and the second prisms 32 were constituted respectively as convex six-sided pyramid prisms and convex three-sided pyramid prisms. However, in the light distribution control member 20, one or both of the first prisms 22 and the second prisms 32 can be constituted as concave by inclined surfaces 28 and 38 formed so as to drop relative to a virtual plane b including each base edge 26. In the present specification, the edges 26 will be referred to as base edges of the inclined surfaces 28 and 38 in this case as well.

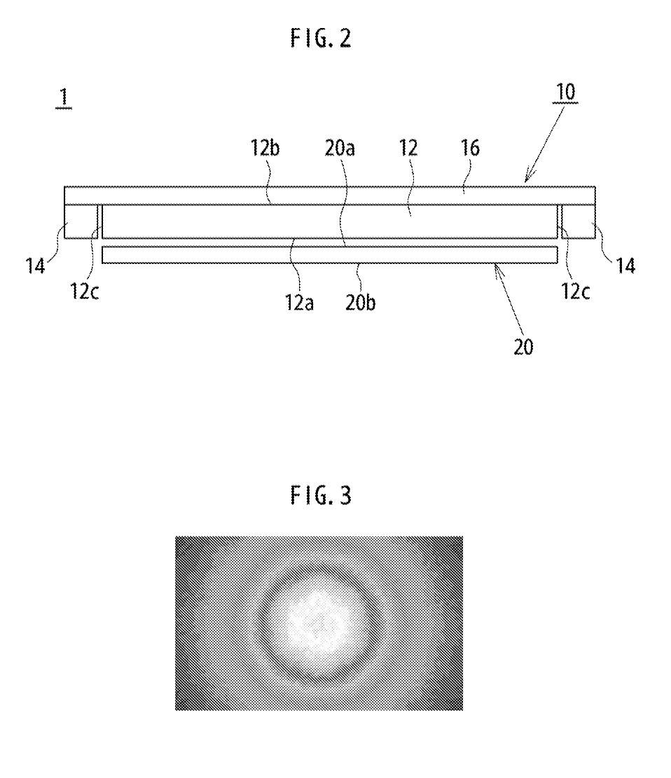

Next, an illuminating device including the light distribution control member 20 will be explained as a second embodiment of the present invention. An illuminating device 1 shown in FIG. 2 includes a light source unit 10 including a light guide plate 12, light sources 14, and a reflective member 16. The light guide plate 12 is a plate-shaped light guide made by molding a transparent resin material such as a methacrylic resin or a polycarbonate resin. The light guide plate 12 is constituted so that one of the principal surfaces is an emitting surface 12a, and the emitting surface 12a is an emitting surface of the light source unit 10.

The light guide plate 12 has quadrilateral principal surfaces, and the side edge surfaces on the four sides are incident light surfaces 12c. The light sources 14 are arranged facing the incident light surfaces 12c. The light sources 14 include, for example, a plurality of light-emitting diodes arranged along the lengthwise direction (direction orthogonal to the paper surface in FIG. 2) of the incident light surfaces 12c. The sheet-like reflective member 16 is disposed on a rear surface 12b side of the light guide plate 12 so as to cover the light, guide plate 12 and the light sources 14.

In the light source unit 10, light which has entered into the light guide plate 12 from the light sources 14 through the incident light surfaces 12c is propagated within the light guide plate 12 while repeating total reflection between the emitting surface 12a and a principal surface (rear surface) 12b on the opposite side of the emitting surface 12a, and in this process, the propagated light is uniformly emitted from the emitting surface 12a. Further, a diffuse reflecting unit or a regular reflecting unit can be provided on the rear surface 12b of the light guide plate 12 to reflect a portion of the light that has entered the rear surface 12b and cause it to enter the emitting surface 12a at an incident angle that is at or below a critical angle.

The illuminating device 1 includes the light distribution control member 20 disposed on the emitting surface 12a side of the light source unit 10. The light distribution control member 20 is formed with a shape and size to cover at least the emitting surface 12a of the light source unit 10 when disposed at a prescribed position. The prism formation surface 20a is arranged facing the emitting surface 12a of the light source unit 10, and the principal surface (rear surface) on the opposite side of the prism formation surface 20a of the light distribution control member 20 is configured as a flat surface 20b.

In the illuminating device 1, light emitted from the emitting surface 12a of the light source unit 10 passes through the light distribution control member 20 from the prism formation surface 20a side toward the flat surface 20b side, and thereby the light emitted from the flat surface 20b, whose light distribution has been controlled, is used as illumination light.

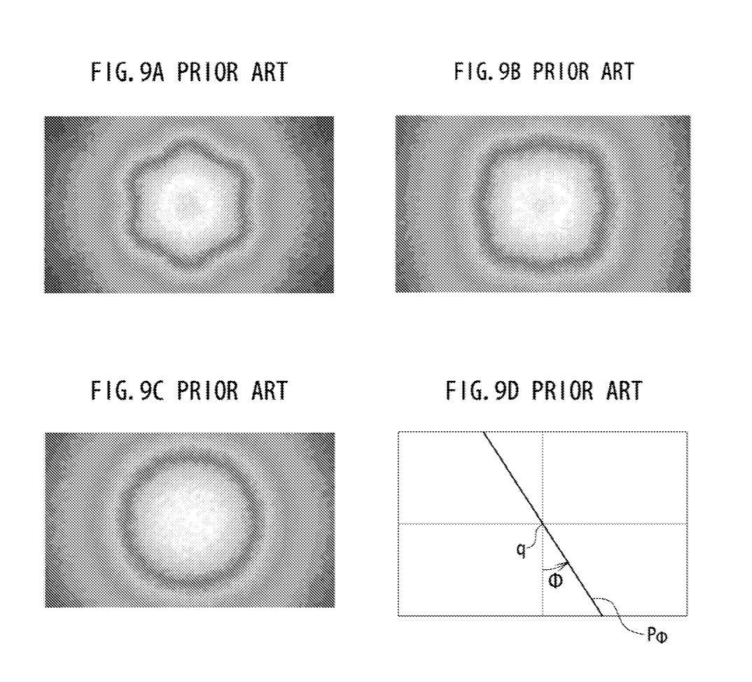

FIG. 3 illustrates the illuminance distribution on the surface to be illuminated in the case that the illuminating device 1 constituted as described above is used. FIG. 3 illustrates the illuminance distribution on the surface to be illuminated as lightness/darkness distributions as in FIGS. 9A to 9C. FIG. 3 is also similar to FIGS. 9A to 9C in that, as shown in FIG. 9D, the center of the drawing corresponds to an intersection of the optical axis q and the surface to be illuminated, and the straight line passing through the center corresponds to an intersection line, of the transect P_{φ} of the azimuth angle φ and the surface to be illuminated.

Comparing FIG. 3 and FIG. 9, it can be understood that in the illuminating device 1 including the light distribution control member 20 having the prism formation surface 20a on which the first prisms (six-sided pyramid prisms) 22 and the second prisms (three-sided pyramid prisms) 32 are mixed and arranged as described above referring to FIG. 1, the uniformity around the optical axis q of the illuminance on the surface to be illuminated does not exhibit non-uniformity like in the cast of only three-sided pyramid prisms shown in FIG. 9A or the case of only four-sided pyramid prisms shown in FIG. 9B, and good uniformity equivalent to that in the case of circular cone prisms shown in FIG. 9C is achieved.

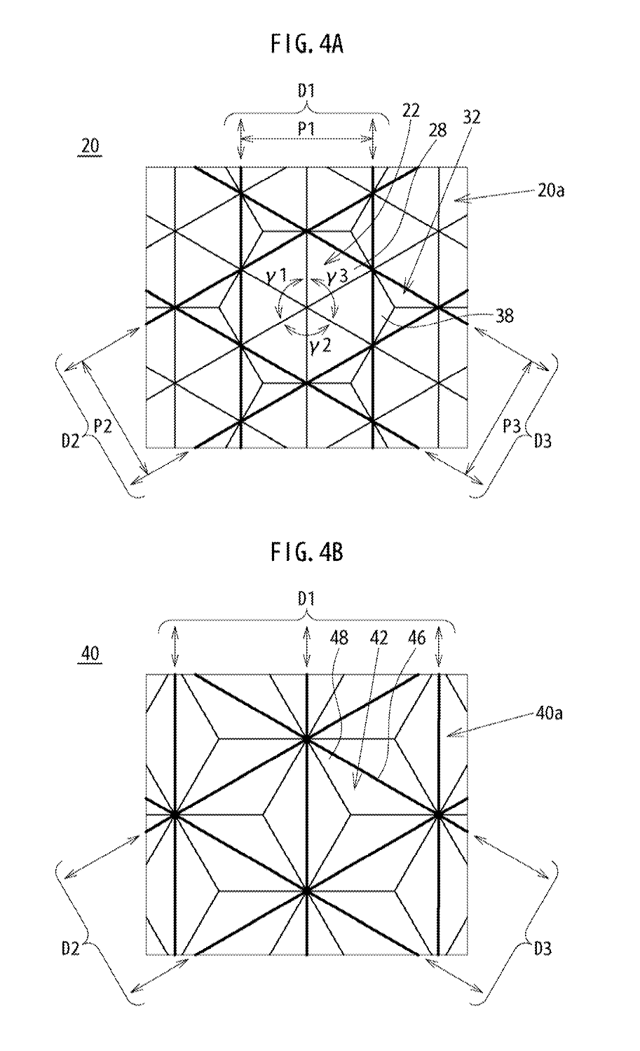

Compared to a light distribution control member having a prism formation surface on which circular cone prisms are arranged, the light distribution control member 20 of the illuminating device 1 that has superior optical characteristics as described above has an advantageous feature in that it is easy to produce. This point will be explained below referring to FIG. 4.

FIG. 4A is a plan view similar to FIG. 1A of the light distribution control member 20 according to the first embodiment of the present invention. FIG. 4B is a plan view viewed from a prism formation surface 40a of a conventional light distribution control member 40 including a prism formation surface on which three-sided pyramid prisms are arranged.

For example, in a production process of the conventional light distribution control member 40, by directly working one principal surface of the light distribution control member 40, in the case of forming the prism formation surface 40a on which convex three-sided pyramid prisms are arranged, a plurality of V-shaped grooves extending in three directions within the principal surface (for example, the up-down direction (D1), the lower left-upper right direction (D2), and the lower right-upper left direction (D3) in FIG. 4B) are formed at prescribed intervals so that the center lines (valley bottoms) of the V-shaped grooves extending in the three directions all intersect at one point. Thereby, a prism formation surface 40a is formed on which a plurality of convex three-sided pyramid prisms 42 that have triangular base surfaces in which the center lines of the V-shaped grooves in the three directions are each base edges 46 and have inclined surfaces 48 constituted by V-shaped inclined surfaces that rise up from the base edges 46 are arranged.

In contrast, in the case that the prism formation surface 20a of the light distribution control member 20 is formed by directly working one principal surface of the light distribution control member 20, as shown in FIG. 4A, V-shaped grooves which are exactly the same as those used in the light distribution control member 40 explained above should be freed such that the intersection point of the center lines (valley bottoms) of the V-shaped grooves in two arbitrary directions does not intersect with the center lines (valley bottoms) of the V-shaped grooves in the remaining one direction. Thereby, a prism formation surface 20a is formed on which the first prisms 22 including convex six-sided pyramid prisms and the second prisms 32 including convex three-sided pyramid prisms are arranged as described above referring to FIG. 1.

In this way, the light distribution control member 20 according to the first embodiment of the present invention can be produced easily and inexpensively without an additional production processes and/or production means (for example, a specialized processing machine or the like) compared to the production process of the conventional light distribution control member 40 having the prism formation surface 40a on which the three-sided pyramid prisms 42 are arranged.

In the light distribution control member 20, in the case that the base surfaces of the first prisms 22 and the base surfaces of the second prisms 32 are respectively hexagonal and triangular as explained above, if the three directions D1, D2, and D3 shown in FIG. 4A are defined such that the angle of D1-D2, the angle of D2-D3, and the angle of D3-D1 are respectively γ1, γ2, and γ3 shown in FIG. 4A, the total of the three angles is 120°. The Plurality of V-shaped grooves extending in the directions D1, D2, and D3 are formed such that their pitches P1, P2, and P3 are all identical and the center line of a V-shaped groove extending in one arbitrary direction (for example, D1) passes over a center point between adjacent intersection points on the center line of one V-shaped groove among the group of intersection points of the coiner lines of the V-shaped grooves extending in the remaining two directions (for example, D2 and D3).

In addition, each V-shaped groove is constituted by two inclined surfaces that rise up symmetrically from the center line (valley bottom), and the distance (groove width) between the end edges on the side at which the inclined surfaces open into a V-shape are set to be identical to the pitch (P1=P2=P3). Thereby, as the first prisms 22, a plurality of convex six-sided pyramid prisms 22 is formed having a hexagonal base surface in which the center lines of the V-shaped grooves in the three directions are each base edges 26 and having inclined surfaces 28 which are each constituted by one of the inclined surfaces of the V-shaped groove that rise up from the base edge 26. As the second prisms 32, a plurality of convex three-sided pyramid prisms 32 is formed having a triangular base surface in which the center lines of the V-shaped grooves in the three directions are each base edges 26, having inclined surfaces 38 which are each constituted by the other of the inclined surfaces of the V-shaped groove that rise up from the base edges 26 (i.e., an inclined surface on the opposite side of the inclined surface that constitutes the inclined surface 28 of the opposing first prism 22), and wherein the height h2 is lower than the height h1 of the first prisms 22. The first prisms 22 and the second prisms 32 are arranged as explained above referring to FIG. 1.

In the production process of the light distribution control member 20, in the case that the prism formation surface 20a is molded using a metal mold, the V-shaped grooves extending in the three directions as described above are formed on the metal mold by cutting using a cutter whose distal end has a prescribed inclined surface. In this case, the prism formation surface 20a molded using a metal mold in which V-shaped grooves are formed as described above includes the first and second prisms 22 and 32 formed in a concave manner. Alternatively, the convex first and second prisms 22 and 32 can be formed by preparing a secondary mold in which the convex portions and the concave portions are inversed by, for example, electrocasting using the above-described metal mold in which V-shaped grooves are formed as a primary mold, and then using the secondary mold as the mold for the prism formation surface 20a.

In either case, it is obvious that no additional production processes and/or production means (for example, a specialized processing machine or the like) are required for the production process of the light distribution control member 20 according to the first embodiment of the present invention compared to the case of producing the conventional light distribution control member 40 having the prism formation surface 40a on which three-sided pyramid prisms 42 are arranged by the same production process.

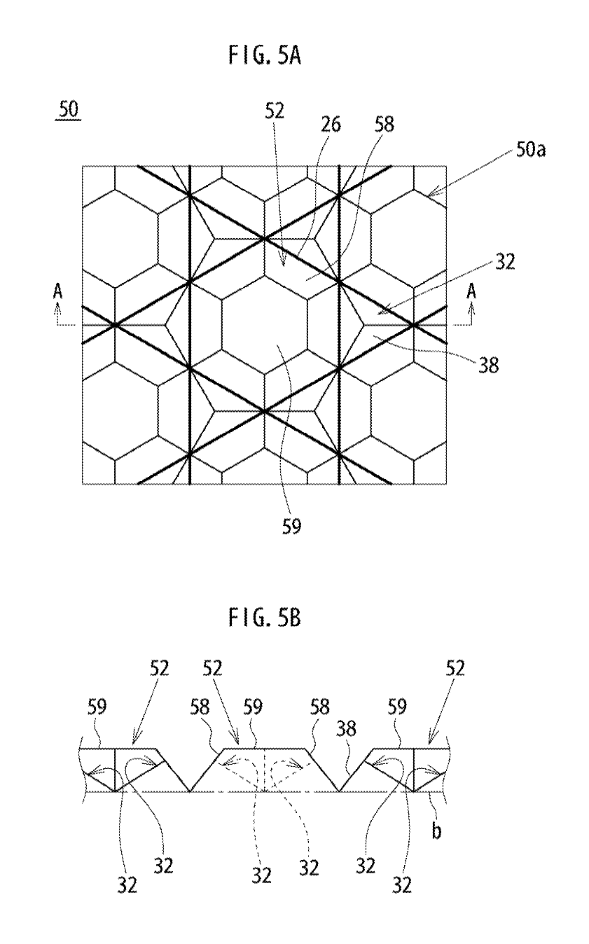

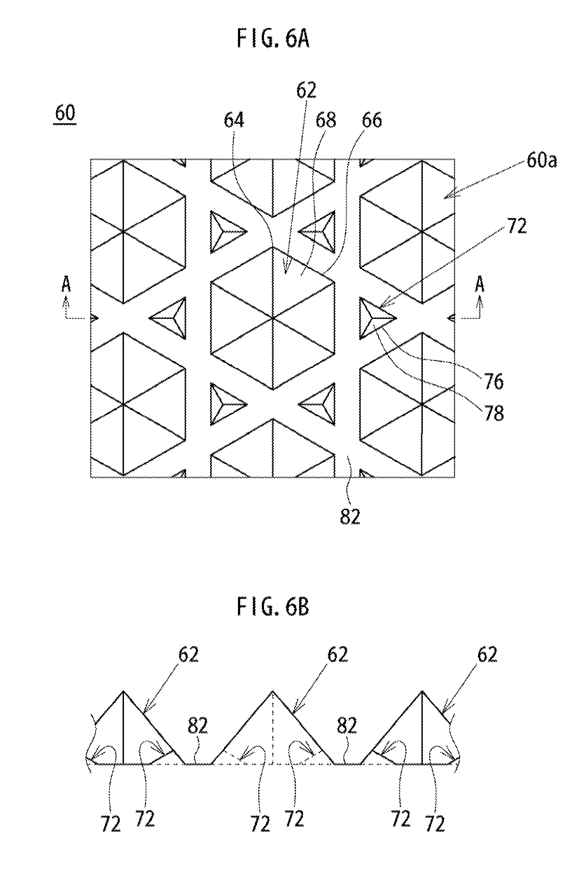

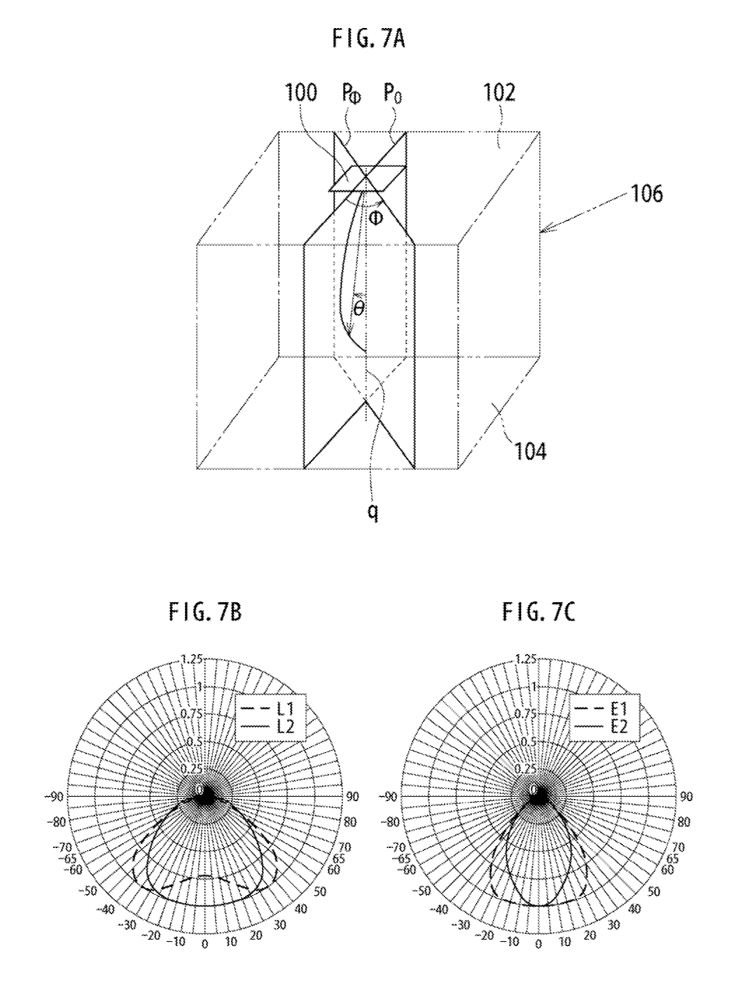

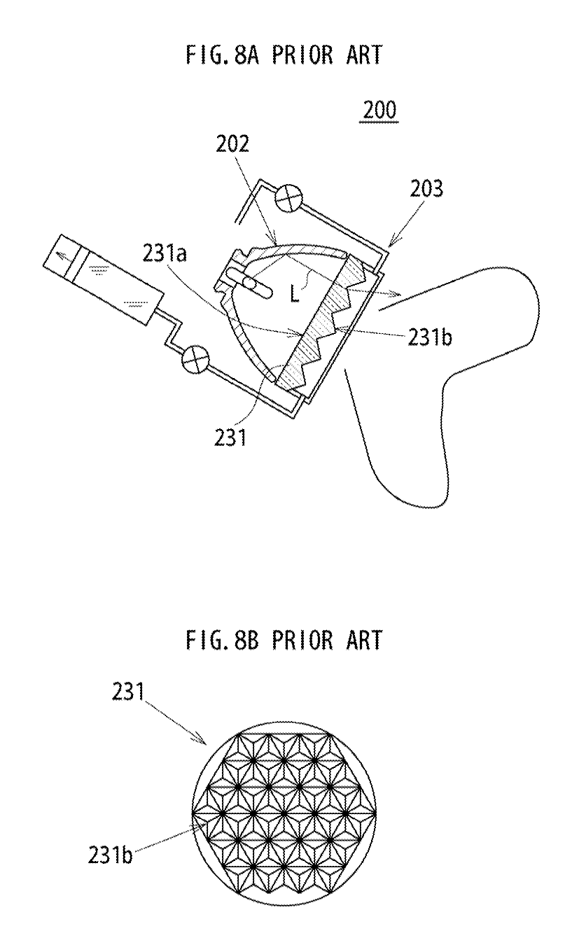

Next, referring to FIGS. 5 and 6, another example of the light distribution control member according to the first embodiment of the present invention will be explained. Below, explanations of the parts which are the same as those in the light distribution control member 20 shown in FIG. 1 will be appropriately omitted, and the explanation will focus on the points of difference.

A light distribution control member 50 shown in FIG. 5 differs from the light distribution control member 20 shown in FIG. 1 in that, in the first prisms 22, inclined surfaces 58 whose base edges are formed by the base edges 26 of a hexagon are truncated, and thereby first prisms 52 are constituted by six-sided truncated pyramid prisms having a flat top surface 59.

If this light distribution control member 50 is utilized in the illuminating device 1, the illumination light that is emitted from the emitting surface 12a of the light source unit 10 and passes through the light distribution control member 50 includes a mixture of light that enters the light distribution control member 50 upon passing through the inclined surfaces 58 and 38 of the first and second prisms 52 and 32 and light that enters the light distribution control member 50 upon passing through the flat top surfaces 59.

Thereby, by adjusting the ratio of the surface area of the inclined surfaces 58 and 38 and the surface area of the flat top surfaces 59 on the prism formation surface 50a, the luminous intensity angular distribution of the illumination light can be arbitrarily adjusted to approach an ideal distribution for achieving a uniform illuminance in a prescribed area on a surface to be illuminated, and the uniformity around the optical axis q of the prescribed illuminance on the surface to be illuminated can also be further improved.

A light distribution control member 60 shown in FIG. 6 differs from the light distribution control member 20 shown in FIG. 1 in that first prisms 62 and second prisms 72 are arranged spaced apart from each other, and thereby fiat surfaces 82 exist around the first prisms 62 and the second prisms 72.

In other words, in the light distribution control member 60, the prism lines in which a plurality of first prisms 62 is lined up in one line along one direction within a prism formation surface 60a are arranged to satisfy the following conditions. One vertex 64 among the vertices 64 of the base surface of one first prism 62 faces with a prescribed distance relative to one vertex 64 among the vertices 64 of the base surface of the adjacent first prism 62. Further, among the vertices 64 of the base surface of one first prism 22, a diagonal line that connects two vertices 64 that face an adjacent first prism will make a single straight line throughout the entire prism line.

In the second prisms 72, base edges 76 of the three inclined surfaces are firmed to extend parallel to and spaced apart by a prescribed distance from respective base edges 66 that define the triangular area in which the second prism 72 is arranged of the three first prisms 62 surrounding the second prism 72. In this respect, the base edges 76 of the three inclined surfaces of the second prism 72 extend along the corresponding base edges 66 of the three first prisms 62.

The light distribution control member 60 achieves the same operational effects as the light distribution control member 50 since it includes flat surfaces 82 on the prism formation surface 60a.

In the light distribution control member 50 shown in FIG. 5, the first prisms 52 have flat top surfaces 59. However in the light distribution control member 50, flat top surfaces can be formed on the second prisms 32 to constitute the second prisms 32 as three-sided truncated pyramid prisms. Alternatively, flat top surfaces can be formed on both of the first prisms 52 and the second prisms 32. In this way, a constitution in which flat top surfaces are formed on one or both of the first prisms 52 and the second prisms 32 can be used in combination with a constitution in which the first and second prisms 62 and 72 are spaced apart from each other as shown in FIG. 6.

In any of the above cases, one or both of the fast prisms 52 and 62 and the second prisms 32 and 72 of the light distribution control members 50 and 60 can be constituted in a concave manner similar to the light distribution control member 20.

The present invention was explained above based on the preferred embodiments, but the present invention is not limited to the above-described embodiments. For example, in the illuminating device the light source unit 10 includes the light guide plate 12 and the light sources 14 arranged on the incident surface 12c of the light guide plate 12. However in the light source unit in the illuminating device according to the present invention, a plurality of light sources (for example, light-emitting diodes) can be arranged in a plane without using a light guide plate. Further, the light source unit can include light sources such as a discharge lamp or an organic electroluminescence element or the like.

What is claimed is:

1. A light distribution control member comprising:
a plurality of first prisms that have inclined surfaces of which each edge of a hexagon is a base edge, and
a plurality of second prisms that have inclined surfaces of which each edge of a triangle is a base edge,
wherein the first prisms are arranged in a houndstooth pattern, and the second prisms are arranged in areas surrounded by three first prisms.

2. The light distribution control member according to claim 1, wherein the second prisms are arranged such that the base edge of each inclined surface of the second prisms extends along a base edge of one of the inclined surfaces of the first prisms.

3. The light distribution control member according to claim 1, wherein the three first prisms surrounding one second prism are arranged in an equilateral triangular pattern.

4. The light distribution control member according to claim 1, wherein the first prisms are six-sided pyramid prisms, and the second prisms are three-sided pyramid prisms.

5. The light distribution control member according to claim 1, wherein the first prisms are six-sided truncated pyramid prisms.

6. The light distribution control member according to claim 1, wherein the first prisms and the second prisms are spaced apart from each other.

7. An illuminating device comprising the light distribution control member according to claim 1 and a light source unit that emits light toward the light distribution control member.

8. The illuminating device according to claim 7, wherein the light source unit includes a light guide plate and a light source arranged on a side edge surface of the light guide plate.
